(19) United States
(12) Patent Application Publication
(10) Pub. No.: US 2025/0222388 A1
(43) Pub. Date: Jul. 10, 2025

(54) APPARATUS FOR IMPROVING EFFICIENCY OF REMOVING POLLUTION DUST IN CHAMBER ENVIRONMENT

(71) Applicant: Yin-Jui SHIH, Changhua County (TW)

(72) Inventor: Yin-Jui SHIH, Changhua County (TW)

(21) Appl. No.: 19/007,962

(22) Filed: Jan. 2, 2025

(30) Foreign Application Priority Data
Jan. 10, 2024 (TW) 113100999

(51) Int. Cl. B01D 46/48; B01D 46/10; B01D 46/42

(52) U.S. Cl. CPC B01D 46/48; B01D 46/10; B01D 46/4263; B01D 2279/50

(57) ABSTRACT

Disclosed is an apparatus for improving efficiency of removing pollution dust in a chamber environment. The apparatus includes: a cavity having a chamber; a dust treatment device disposed in the chamber, comprising a filter screen structure and a dust collecting tank; and a dust extracting device comprising an airflow outlet pipe, an extractor, and an airflow inlet pipe. One end of the airflow outlet pipe is connected to the dust collecting tank, and the other end can be connected to a cooler, a filter, the extractor, or a heater. One end of the airflow inlet pipe is connected to rear end of the extractor, and the other end is connected to the chamber. The apparatus can intercept more dust, increase airflow, collect the dust, and discharge it from the chamber to prevent secondary pollution. After dust removal, gas is heated for reuse.

### CROSS-REFERENCE TO RELATED APPLICATIONS

The application claims priority to Taiwan patent application No. 113100999, filed on Jan. 10, 2024, the entire contents of which are incorporated herein by reference.

### TECHNICAL FIELD

The present invention relates to the technical field of controlling an airflow in a chamber environment to improve the dust removal efficiency, and in particular to an apparatus for improving efficiency of removing pollution dust in a chamber environment. The apparatus can intercept more dust and control the air volume at the same time, and can collect the dust and discharge it from the chamber to prevent secondary pollution, and the heated gas after dust removal can be sent back to the chamber for reuse.

### BACKGROUND

According to a conventional method, a filter screen is mounted in a chamber environment, and pollution dust is intercepted by controlling the circulation of an airflow in the chamber environment and allowing the airflow to pass through the filter screen, in such a manner the cleanliness of the chamber environment is gradually improved. The problems are as follows: (1) if a filter screen with a high density is adopted, more dust will be intercepted each time, but because of the high density of the filter screen, the volume of the airflow passing through it is reduced, leading to the low dust filtration efficiency; (2) if a filter screen with a low density is adopted, less dust will be intercepted each time, but because of the low density of the filter screen, the volume of the airflow passing through it is relatively high, leading to a low filtering effect; (3) if the filter screen is used for a long time to reach filtration saturation and the filter screen is not replaced in time, it may lead to the problem that the filter screen which should be used for filtering dust will produce dust pollution instead; (4) in addition, in a high-temperature chamber environment, a material or a manufacturing method of the filter screen may lead to the problem that the filter screen which should be used for filtering dust will produce dust pollution instead; and (5) a large airflow may cause the vibration and friction of substances in the chamber environment to produce dust; in addition, volatiles generated by general baking objects will stick to any place where the airflow flows in a baking cavity with the flow of the internal airflow, which will result in the difficulty in cleaning the volatiles in the chamber. Thus, it is necessary to improve the prior art.

Therefore, in view of the problems existing in the above-mentioned conventional structure, how to develop a more ideal and practical innovative structure is the ardent expectation of consumers, and it is also the goal and direction that relevant industries must strive for research and development breakthroughs.

In view of this, the inventor, who has been engaged in the manufacturing, development and design experience of related products for many years, has finally invented the apparatus with practicability after detailed design and careful evaluation.

### SUMMARY

An embodiment of the invention provides an apparatus for controlling an airflow in a chamber environment to improve efficiency of removing pollution dust in a chamber environment. The apparatus can improve the efficiency of intercepting dust, and can collect dust and discharge it from the chamber to prevent secondary pollution, and the heated gas after dust removal can be sent back to the chamber for reuse, thus effectively enhancing the dust removal ability in the chamber environment.

Another embodiment of the invention provides an apparatus for controlling an airflow in a chamber environment to improve the efficiency of removing pollution dust in the chamber environment. The apparatus can collect most of the pollutants volatilized from baking objects through a dust treatment device and discharge them from a cavity through a dust extracting device with the adsorption capacity, thus effectively reducing the difficulty in cleaning the volatiles in the cavity.

Based on the above, an apparatus for improving efficiency of removing pollution dust in a chamber environment is provided. The apparatus includes: a cavity, where a chamber is provided in the cavity; a dust treatment device, where the dust treatment device is disposed in the chamber, and the dust treatment device internally includes a filter screen structure and a dust collecting tank; and a dust extracting device, where the dust extracting device includes an airflow outlet pipe, an extractor and an airflow inlet pipe, the airflow outlet pipe is connected to the dust collecting tank, the other end of the airflow outlet pipe can be connected to a cooler, a filter, the extractor or a heater, one end of the airflow inlet pipe is connected to the heater, and the other end of the airflow inlet pipe is connected to the chamber, so that the filtered heated gas can be sent back. Accordingly, the apparatus can intercept more dust and control the air volume at the same time, and can collect the dust and discharge it from the chamber to prevent secondary pollution; and after dust removal, a temperature of gas after heating is raised, and the gas can be sent back to the chamber for reuse.

As will be appreciated, the above-mentioned objectives, configurations and features of the embodiment of the present invention will be thoroughly and particularly understood from the above-mentioned techniques, means and effects of the embodiment of the present invention, which are described in detail with reference to preferred embodiments thereof and the drawings.

### BRIEF DESCRIPTION OF DRAWINGS

FIG. 1 is a plan sectional view of an embodiment of the invention.

FIG. 2 is an exploded perspective view along a direction of an embodiment of the invention.

FIG. 3 is an exploded perspective view along another direction of an embodiment of the invention.

FIG. 4 is a system flow diagram of an embodiment of the invention.

### DETAILED DESCRIPTION OF THE EMBODIMENTS

In order to make examiners have a better understanding of the objectives, features and effects of the embodiment of the present invention, the following is detailed with the implementation and drawings.

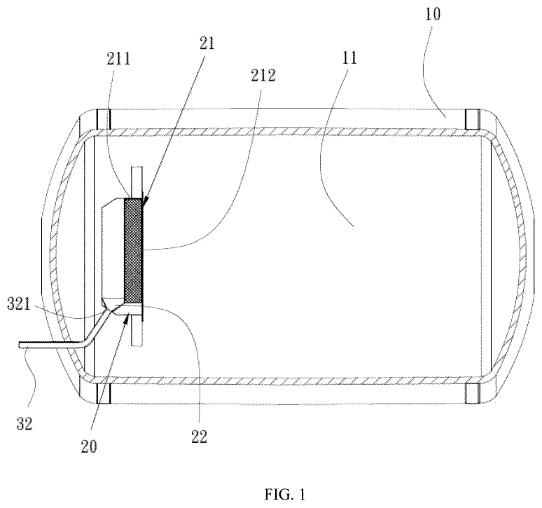

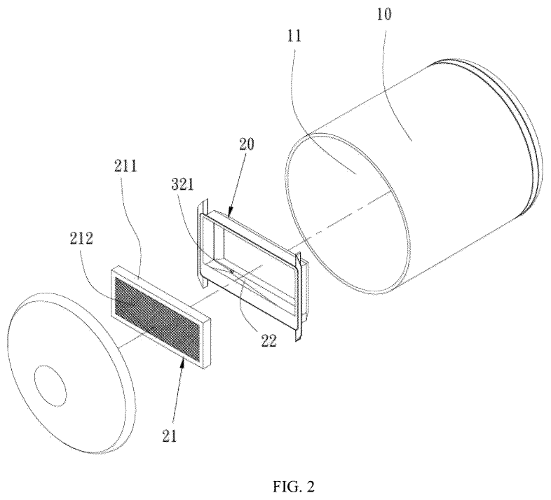

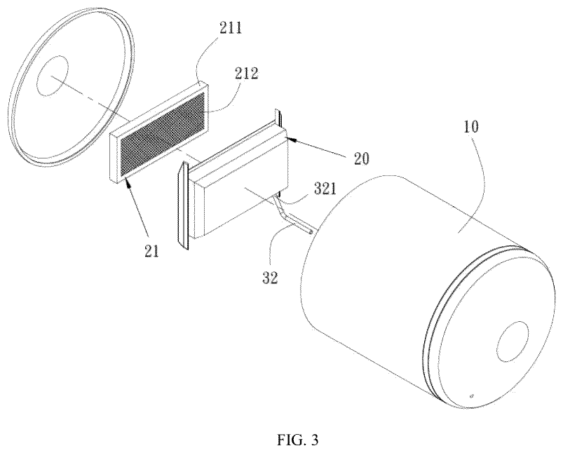

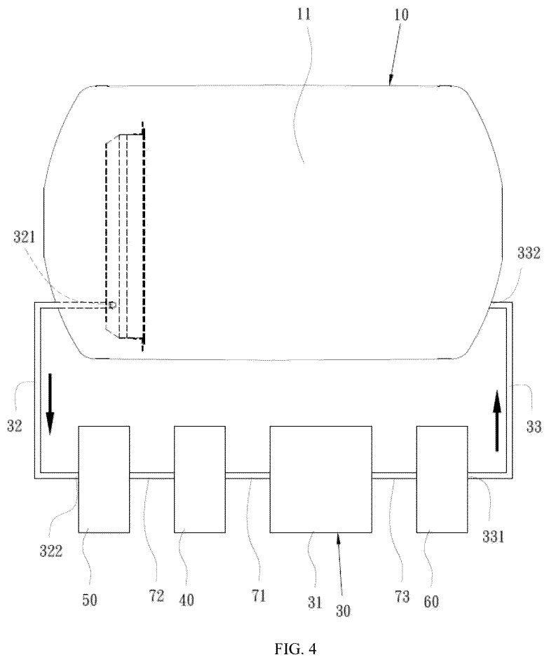

With reference to FIG. 1 to FIG. 4, which shows an apparatus for improving efficiency of removing pollution dust in a chamber environment according to an embodiment of the invention, including:
a cavity 10, where a chamber 11 is provided in the cavity 10;
a dust treatment device 20, where the dust treatment device 20 is disposed in the chamber 11, a filter screen structure 21 is disposed at a front of an interior of the dust treatment device 20, a dust collecting tank 22 is disposed at a rear of the dust treatment device 20, and the dust collecting tank 22 collects dust passing through the filter screen structure 21 or falling from the filter screen structure 21; and
a dust extracting device 30, where the dust extracting device 30 includes an extractor 31, an airflow outlet pipe 32 and an airflow inlet pipe 33, one end 321 of the airflow outlet pipe 32 is connected to the dust collecting tank 22 in the dust treatment device 20 for dust collection, the other end 322 of the airflow outlet pipe 32 is connected to a front end of the extractor 31, one end 331 of the airflow inlet pipe 33 is connected to a rear end of the extractor 31, and the other end 332 of the airflow inlet pipe 33 is connected to the chamber 11, so that gas flows back into the chamber 11 after dust removal. The dust collecting tank 22 can perform a dust collecting action, and then the dust and volatiles generated by baking objects can be forcibly discharged from the chamber 11 through the extractor 31 in cooperation with the airflow outlet pipe 32, so that secondary pollution can be avoided.

In the apparatus for improving efficiency of removing pollution dust in a chamber environment, the other end 322 of the airflow outlet pipe 32 can be connected to a filter 40 first, and then the filter 40 is connected to the front end of the extractor 31 through a first intermediate pipeline 71. By means of the filter 40 which filters out the dust and the volatiles generated by the baking objects extracted from the dust collecting tank 22, it is ensured that the dust and the volatiles can be effectively removed, and that the dust and the volatiles are prevented from flowing back into the chamber 11, so that the dust and the volatiles in the chamber 11 can be reduced. In addition, when there are more volatiles which are sticky and difficult to clean, the other end 322 of the air outlet pipe 32 can be connected to the filter 40 first, and then connected to the extractor 31, so that the pollution to the extractor 31 by the volatiles can be reduced. When there is a lot of dust, the other end 322 of the airflow outlet pipe 32 can be connected to the extractor 31 first and then connected to the filter 40, so that the dust removal effect of the filter 40 can be effectively improved.

In the apparatus for improving efficiency of removing pollution dust in a chamber environment, the other end 322 of the airflow outlet pipe 32 can be connected with a cooler 50 first, and then the cooler 50 is connected to the filter 40 through a second intermediate pipeline 72. The cooler 50 cools the gas, so that the filter 40 avoids the problem of dust generation or reduction in the service life due to the high-temperature chamber. Since the high-temperature chamber will make the filter screen generate dust, cooling through the cooler 50 can solve this problem and it is ensured that the filter 40 can effectively filter dust and volatiles. In addition, the cooler can also be regarded as a filter for the volatiles generated by baking in the chamber, due to the fact that the cooler has the effect of condensing the volatiles.

In the apparatus for improving efficiency of removing pollution dust in a chamber environment, the rear end of the extractor 31 can be connected to a third intermediate pipeline 73 first, then the third intermediate pipeline 73 can be connected to a heater 60, the heater 60 heats the gas flowing back to the front of the chamber 11, and the heater 60 is then connected to one end 331 of the airflow inlet pipe 33. The cooled gas may change a working temperature in the chamber 11, so that the gas may be heated to an appropriate temperature before it can be sent back to the chamber 11, thereby avoiding affecting the working temperature in the chamber 11.

In the apparatus for improving efficiency of removing pollution dust in a chamber environment, the filter screen structure 21 includes an outer frame 211 and an inner filter screen 212.

In the apparatus for improving efficiency of removing pollution dust in a chamber environment, a material of the inner filter screen 212 is non-woven fabric, Teflon cloth or stainless steel.

In the apparatus for improving efficiency of removing pollution dust in a chamber environment, a filter screen (not shown) is disposed inside the filter 40, and a material of the filter screen is non-woven fabric, Teflon cloth or stainless steel.

In the apparatus for improving efficiency of removing pollution dust in a chamber environment, the extractor 31 is a fan or a pump.

In the apparatus for improving efficiency of removing pollution dust in a chamber environment, the extractor 31 is a variable frequency extractor.

In the apparatus for improving efficiency of removing pollution dust in a chamber environment, the dust collecting tank 22 can collect volatile-containing gas passing through the filter screen structure 21.

As can been seen from the above, the apparatus for improving efficiency of removing pollution dust in a chamber environment is the first in the industry and meets the novelty requirement of the invention patent, its comprehensive innovative design meets the progressive requirement of the invention patent, it can intercept more dust and control the air volume at the same time, and can collect dust and discharge it from the chamber to prevent secondary pollution, and heated gas after dust removal can be sent back to the chamber for reuse, so that the apparatus is in line with better industrial utilization.

The foregoing has been specifically described with reference to preferred embodiments of the present invention as technical features of the present invention. However, those skilled in the art can make changes and modifications to the present invention without departing from the spirit and principles of the present invention, and such changes and modifications should be included within in the scope of the patent application below.

In summary, the apparatus for improving efficiency of removing pollution dust in a chamber environment provided by the embodiment of the present invention has achieved all the objectives of the present invention, and a spatial pattern of its combined structure has not been found in similar products, nor has it been disclosed before the present application, and the present invention has complied with the provisions of the patent law, and thus is filed according to the patent law.

### NUMERAL REFERENCES

10 cavity
11 chamber
20 dust treatment device
21 filter screen structure
211 outer frame
212 inner filter screen
22 dust collecting tank
30 dust extracting device
31 extractor
32 airflow outlet pipe
321 one end
322 the other end
33 airflow inlet pipe
331 one end
332 the other end
40 filter
50 cooler
60 heater
71 first intermediate pipeline
72 second intermediate pipeline
73 third intermediate pipeline

What is claimed is:

1. An apparatus for improving efficiency of removing pollution dust in a chamber environment, comprising:
a cavity, wherein a chamber is provided in the cavity;
a dust treatment device, wherein the dust treatment device is disposed in the chamber, a filter screen structure is disposed at a front of an interior of the dust treatment device, a dust collecting tank is disposed at a rear of the dust treatment device, and the dust collecting tank collects dust passing through the filter screen structure or falling from the filter screen structure; and
a dust extracting device, wherein the dust extracting device comprises an extractor, an airflow outlet pipe and an airflow inlet pipe, one end of the airflow outlet pipe is connected to the dust collecting tank in the dust treatment device for dust collection, the other end of the airflow outlet pipe is connected to a front end of the extractor, one end of the airflow inlet pipe is connected to a rear end of the extractor, and the other end of the airflow inlet pipe is connected to the chamber, so that gas flows back into the chamber after dust removal.

2. The apparatus for improving efficiency of removing pollution dust in a chamber environment according to claim 1, wherein the other end of the airflow outlet pipe is connected to a filter first, then the filter is connected to the front end of the extractor through a first intermediate pipeline, and dust and volatiles are extracted through the dust collecting tank by means of the filter.

3. The apparatus for improving efficiency of removing pollution dust in a chamber environment according to claim 2, wherein the other end of the airflow outlet pipe is connected to a cooler, then the cooler is connected with the filter through a second intermediate pipeline, and the gas is cooled by the cooler.

4. The apparatus for improving efficiency of removing pollution dust in a chamber environment according to claim 3, wherein the rear end of the extractor is connected to a third intermediate pipeline first, then the third intermediate pipeline is connected to a heater, the heater heats the gas flowing back to the front of the chamber, and the heater is then connected to one end of the airflow inlet pipe.

5. The apparatus for improving efficiency of removing pollution dust in a chamber environment according to claim 1, wherein the filter screen structure comprises an outer frame and an inner filter screen.

6. The apparatus for improving efficiency of removing pollution dust in a chamber environment according to claim 5, wherein a material of the inner filter screen is non-woven fabric, Teflon cloth or stainless steel.

7. The apparatus for improving efficiency of removing pollution dust in a chamber environment according to claim 2, wherein a filter screen is disposed inside the filter, and a material of the filter screen is non-woven fabric, Teflon cloth or stainless steel.

8. The apparatus for improving efficiency of removing pollution dust in a chamber environment according to claim 1, wherein the extractor is a fan or a pump.

9. The apparatus for improving efficiency of removing pollution dust in a chamber environment according to claim 8, wherein the extractor is a variable frequency extractor.

10. The apparatus for improving efficiency of removing pollution dust in a chamber environment according to claim 1, wherein the dust collecting tank is further collecting volatile-containing gas passing through the filter screen structure.
